(19) United States
(12) Patent Application Publication
(10) Pub. No.: US 2015/0029419 A1
(43) Pub. Date: Jan. 29, 2015

(54) DECORATION PLATE AND TOUCH PANEL

(71) Applicant: WINTEK CORPORATION, Taichung City (TW)

(72) Inventors: Chun-Ming Huang, Taichung City (TW); Jen-Wei Chou, Taichung City (TW); Cheng-Hsiu Liu, Taichung City (TW); Ta-Wei Yeh, Taichung City (TW)

(21) Appl. No.: 14/335,959

(22) Filed: Jul. 21, 2014

(30) Foreign Application Priority Data
Jul. 26, 2013 (TW) 102126908

(51) Int. Cl. G02B 5/22; G06F 1/16

(52) U.S. Cl. CPC G02B 5/223; G06F 1/169
USPC 349/12; 428/201; 428/138; 428/189

(57) ABSTRACT

A decoration plate includes a substrate, a decoration pattern layer, and at least one color decoration layer. The decoration pattern layer is disposed on the substrate, and the decoration pattern layer has a pattern in a projection direction perpendicular to the substrate. The color decoration layer is disposed on and covers the decoration pattern layer, and extends onto the substrate.

### BACKGROUND OF THE INVENTION

1. Field of the Invention

The present invention relates to a decoration plate and a touch panel, and more particularly, to a decoration plate and a touch panel having a decoration pattern layer disposed between a substrate and a color decoration layer.

2. Description of the Prior Art

Because of the intelligent characteristics of human-computer interaction, touch panels have been widely applied to display devices to form touch display panels, such as mobile phone, GPS navigator system, tablet PC, PDA and laptop PC.

Since the touch pane adheres to a display surface of the display device, a user can directly see the touch panel. In order to show a required frame color and a pattern, such as trade mark, on the touch display device and to shield conductive lines of the touch panel or other unintended appearance, the conventional touch panel includes the color decoration layer and the decoration material layer. In the method for manufacturing the conventional touch panel, the color decoration layer is formed on the substrate to provide a frame with a color and to define a non-display region of the touch panel. Also, the color decoration layer has patterned holes exposing the substrate and showing required patterns. After forming the color decoration layer, a lithographic process is performed to form a touch sensing unit on the substrate, and then, a decoration material layer is formed on the color decoration layer and filled within the patterned holes. Accordingly, the pattern shown from the outer surface of the substrate may have the color of the decoration material layer. However, when the color of the frame is white or non-black, the color decoration layer is formed as a multilayer structure. Thus, a printing tolerance between the color decoration layers is generated, and edges of the color decoration layers in the patterned holes are not aligned to one another. Hence, the transmittance in the edge of the pattern formed by filling the decoration material layer within the patterned holes is not even, thereby causing bad appearance.

Therefore, when the color decoration layer is a multilayer structure, to improve the appearance of the touch panel to avoid the appearance of the pattern in the non-displaying region being bad is an objective in this field.

### SUMMARY OF THE INVENTION

It is a primary objective of the present invention to provide a decoration plate and a touch panel to improve the appearance of the decoration plate and the touch panel and avoid the appearance of the pattern in the non-displaying region being bad.

According to an embodiment of the present invention, a decoration plate having a light-shielding region is provided. The decoration plate includes a substrate, a decoration pattern layer, and at least one color decoration layer. The decoration pattern layer is disposed on the substrate in the light-shielding region, and defines at least one pattern in a projection direction perpendicular to the substrate. The color decoration layer covers the decoration pattern layer and extends onto the substrate.

According to another embodiment of the present invention, a touch panel having a light-transmission region and a light-shielding region disposed adjacent to the light-transmission region is provided. The touch panel includes a first substrate, a decoration pattern layer, at least one color decoration layer, and a touch sensing unit. The decoration pattern layer is disposed on the first substrate in the light-shielding region, and defines at least one pattern in a projection direction perpendicular to the first substrate. The color decoration layer covers the decoration pattern layer and extends onto the first substrate. The touch sensing unit is at least disposed in the light-transmission region.

In the present invention, the decoration pattern layer is formed on the inner surface of the first substrate prior to the step of forming the color decoration layer on the decoration pattern layer and the inner surface of the first substrate, so that the pattern of the decoration pattern layer can be directly seen from the outer surface of the first substrate, and the color decoration layer can be served as a protection layer of the decoration pattern layer. Accordingly, the visual effect of the appearance of the pattern on the decoration plate and the touch panel can be improved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a part of a top view of a decoration plate according to a first embodiment of the present invention.

FIG. 2 is a cross-sectional view of the decoration plate shown in FIG. 1 along a cross line A-A′.

FIG. 3 is a schematic diagram illustrating a part of a top view of a decoration plate according to a second embodiment of the present invention.

FIG. 4 is a cross-sectional view of the decoration plate shown in FIG. 3 along a cross line D-D′.

FIG. 5 is a schematic diagram illustrating a cross-sectional view of a decoration plate according to a third embodiment of the present invention.

FIG. 6 is a schematic diagram illustrating a part of a top view of a decoration plate according to a fourth embodiment of the present invention.

FIG. 7 is a cross-sectional view of the decoration plate shown in FIG. 6 along a cross line B-B′.

FIG. 8 is a schematic diagram illustrating a top view of a decoration plate according to a fifth embodiment of the present invention.

FIG. 9 is a cross-sectional view of the decoration plate shown in FIG. 8 along a cross line C-C′.

FIG. 10 and FIG. 11 are schematic diagrams illustrating touch panels according to a sixth embodiment and a seventh embodiment of the present invention respectively.

FIG. 12 is a schematic diagram illustrating a cross-sectional view of a touch panel according to an eighth embodiment of the present invention.

### DETAILED DESCRIPTION

To provide a better understanding of the present invention, preferred exemplary embodiments will be described in detail. The preferred exemplary embodiments of the present invention are illustrated in the accompanying drawings with numbered elements.

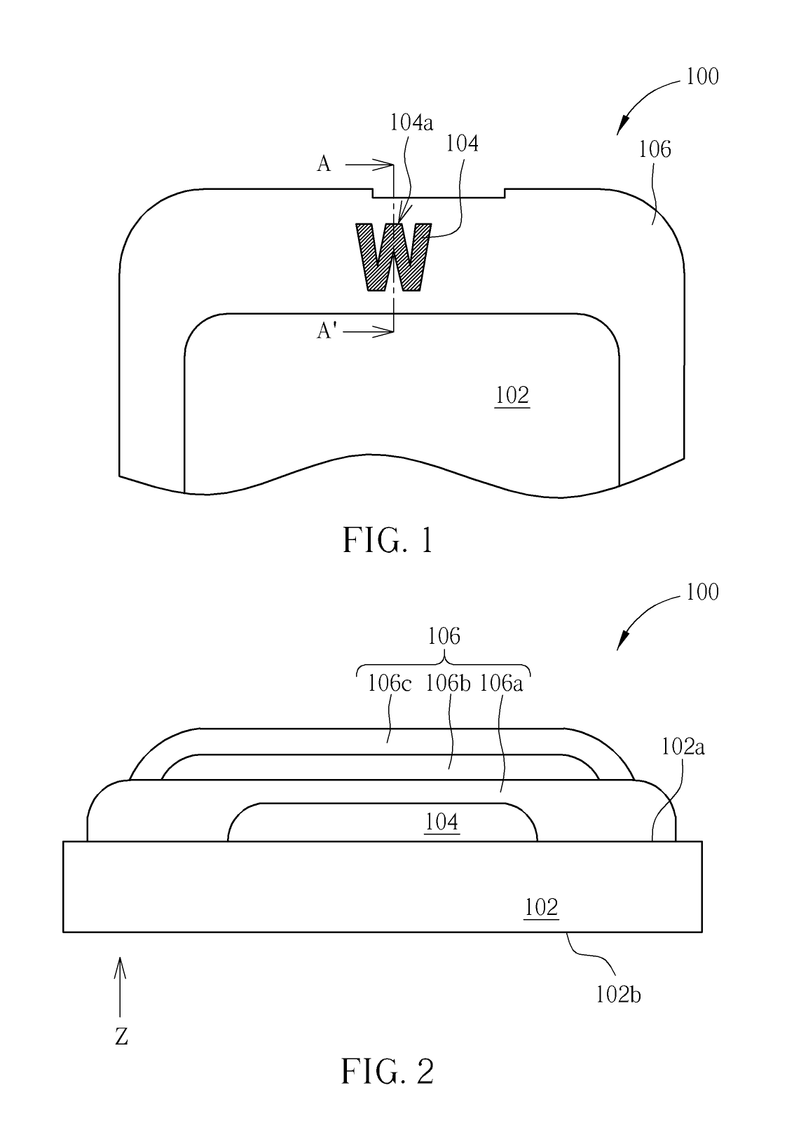

Referring to FIG. 1 and FIG. 2, FIG. 1 is a schematic diagram illustrating a part of a top view of a decoration plate according to a first embodiment of the present invention, and FIG. 2 is a cross-sectional view of the decoration plate shown in FIG. 1 along a cross line A-A′. In order to clear show the features of the present invention, FIG. 1 only shows a part of the decoration plate, but the present invention is not limited thereto. As shown in FIG. 1 and FIG. 2, the decoration plate 100 of the present invention includes a first substrate 102, a decoration pattern layer 104, and at least one color decoration layer 106. The first substrate 102 has an inner surface 102a, and the first substrate 102 may be, for example, strengthened glass substrate, plastic substrate or flexible film, wherein the glass substrate may be curved and a material of the flexible film may be, for example, polyethylene terephthalate (PET) film, but the present invention is not limited thereto. The decoration pattern layer 104 is disposed on the inner surface 102a of the first substrate 102 to define at least one pattern 104a, such as a trade mark of a product or a symbol representing a function, in a projection direction Z perpendicular to the first substrate 102, so that a user may see the pattern 104a from an outer surface 102b of the first substrate 102 opposite to the inner surface 102a through the first substrate 102. In this embodiment, the decoration pattern layer 104 may include ink, such as mirrored silver ink or other type inks with metal dopant, and the decoration pattern layer 104 may be formed on the first substrate 102 by a screen printing process with a patterned screen. Preferably, the decoration pattern layer 104 may include a metal pigment, so as to provide a pattern with quality. In other embodiments of the present invention, the decoration layer may also include photoresist, and is formed on the first substrate by a photolithographic process. Or, the decoration pattern layer may be formed by a lithographic process, an inkjet printing process or a coating process.

In addition, the color decoration layer 106 is disposed on and covers the decoration pattern layer 104, so that the color decoration layer 106 may be served as a protection layer of the decoration pattern layer 104. The color decoration layer 106 may extend onto the inner surface 102a of the first substrate 102 so as to define a light-shielding region of the decoration plate 100. Accordingly, the color decoration layer 106 may present a desired color outside the pattern 104a, and the user may see the color of the color decoration layer 106 surrounding the pattern 104a from the outer surface 102b of the first substrate 102. For clearly showing the pattern 104a, the color of the color decoration layer 106 may be different from the color of the decoration pattern layer 104, and is preferable to distinguish the difference through naked eyes. Moreover, the color decoration layer 106 may include ink, such as black ink, white ink or colored ink, and may be formed on the decoration pattern layer 104 and the first substrate 102 through the screen printing process. In this embodiment, in order to have better shielding performance and optical density, the color decoration layer 106 may include a first color decoration layer 106a, a second color decoration layer 106b, and a third color decoration layer 106c, sequentially stacked on the decoration pattern layer 104 and the first substrate 102. The color of the first color decoration layer 106a, the color of the second color decoration layer 106b and the color of the third color decoration layer 106c preferably are a same color or colors with a same color scheme, for example, they are formed by the same white ink, but the present invention is not limited thereto. Furthermore, an area of the second color decoration layer 106b is smaller than an area of the first color decoration layer 106a. An area of the third color decoration layer 106c is larger than the area of the second color decoration layer 106b and smaller than the area of the first color decoration layer 106a. Accordingly, the first color decoration layer 106a, the second color decoration layer 106b and the third color decoration layer 106c can be stacked to have uniform color. In other embodiments of the present invention, the color decoration layer is not limited to have three-layer structure, and may be a single-layer or multi-layer structure. Also, the color decoration layer may include photoresist, and is formed on the first substrate by a photolithographic process. Or, the color decoration layer may be formed by a lithographic process, an inkjet printing process or a coating process.

It should be noted that the decoration pattern layer 104 is formed on the inner surface 102a of the first substrate 102 prior to the color decoration layer 106 formed on the decoration pattern layer 104 and the inner surface 102a of the first substrate 102 in this embodiment. Thus, the pattern 104a of the decoration pattern layer 104 can be directly seen from the outer surface 102b of the first substrate 102, and the color decoration layer 106 can be used to protect the decoration pattern layer 104. In addition, the first substrate 102 provides the protection function for the decoration pattern layer 104 and the color decoration layer 106 disposed thereon, but the present invention is not limited thereto. Moreover, the devices including the above decoration layer, the touch sensing unit and the display covered by the first substrate 102 can be accordingly protected.

The decoration plate of the present invention is not limited to the illustrated exemplary embodiment. To simplify the explanation and to clarify the comparison, the same components are denoted by the same numerals in the following exemplary embodiments or derivative embodiments, and the repeated parts are omitted herein for brevity.

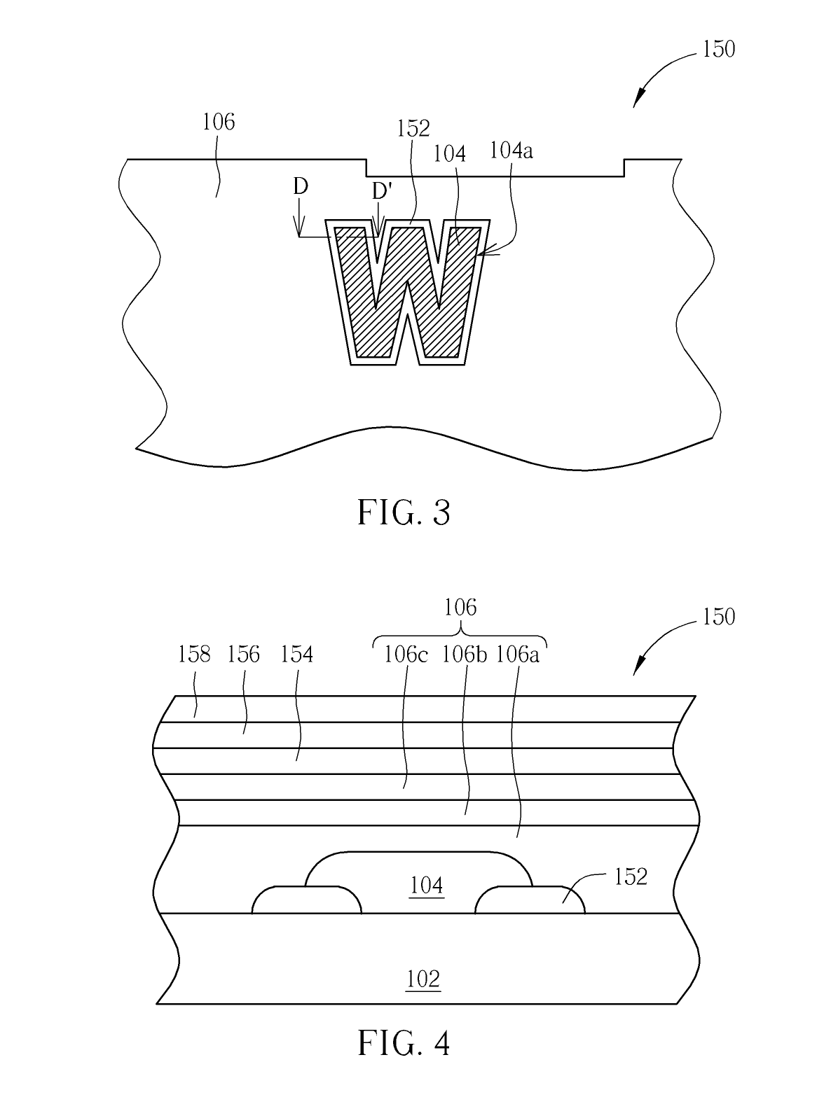

Referring to FIG. 3 and FIG. 4, FIG. 3 is a schematic diagram illustrating a part of a top view of a decoration plate according to a second embodiment of the present invention, and FIG. 4 is a cross-sectional view of the decoration plate shown in FIG. 3 along a cross line D-D′. As shown in FIG. 3 and FIG. 4, in comparison with the first embodiment, the decoration plate 150 of this embodiment further includes an edge decoration layer 152 disposed between an edge of the decoration pattern layer 104 and the first substrate 102 and along the edge of the decoration pattern layer 104. In other words, the edge decoration layer 152 overlap the edge of the decoration pattern layer 104 in a projection direction Z perpendicular to the first substrate 102. It should be noted that when the decoration pattern layer 104 is manufactured by the screen printing process, the edge of pattern 104a formed by the decoration pattern layer 104 is not smooth enough. In other words, the roughness of the edge of pattern 104a does not meet the requirement of design. In this embodiment, the edge decoration layer 152 is formed by the photolithographic process, thereby having more even edge as compared with the decoration pattern layer 104. Accordingly, the edge decoration layer 152 disposed between the edge of the decoration pattern layer 104 and the first substrate 102 can shield the rough edge of the decoration pattern layer 104, such that the pattern 104a shown from the first substrate 102 has an even edge. In this embodiment, the edge decoration layer 152 and the color decoration layer 106 have a same color, wherein the edge decoration layer 152 includes photoresist or metal, but the present invention is not limited to this. In other embodiments, the edge decoration layer and the color decoration layer may have different colors, thereby providing pattern frame with different visual effects.

In this embodiment, the decoration plate 150 may further include a buffer layer 154, a first light-shielding layer 156, and a protection layer 158 sequentially stacked on the color decoration layer 106. The first light-shielding layer 156 is disposed on the color decoration layer 106 to enhance light-shielding effect and optical density. The first light-shielding layer 156 of this embodiment may include, for example, black or grey photoresist, black or grey ink or metallic material, but the present invention is not limited thereto. The buffer layer 154 is disposed between the color decoration layer 106 and the first light-shielding layer 156 to avoid bad appearance of the decoration plate 150 caused by the material of the first light-shielding layer 152 polluting the color of the color decoration layer 106. The buffer layer 154 may include an insulating material, such as silicon oxide, but the present invention is not limited thereto. In other embodiment, the buffer layer 154 is a multilayer structure consisting of two layers or three layers. In the embodiment of the two layer structure, the two layers comprise an organic layer and a non-organic layer stacked with each other. Also, the protection layer 158 may be used to protect the first light-shielding layer 15 and the color decoration layer 106 disposed thereunder from damage from external forces.

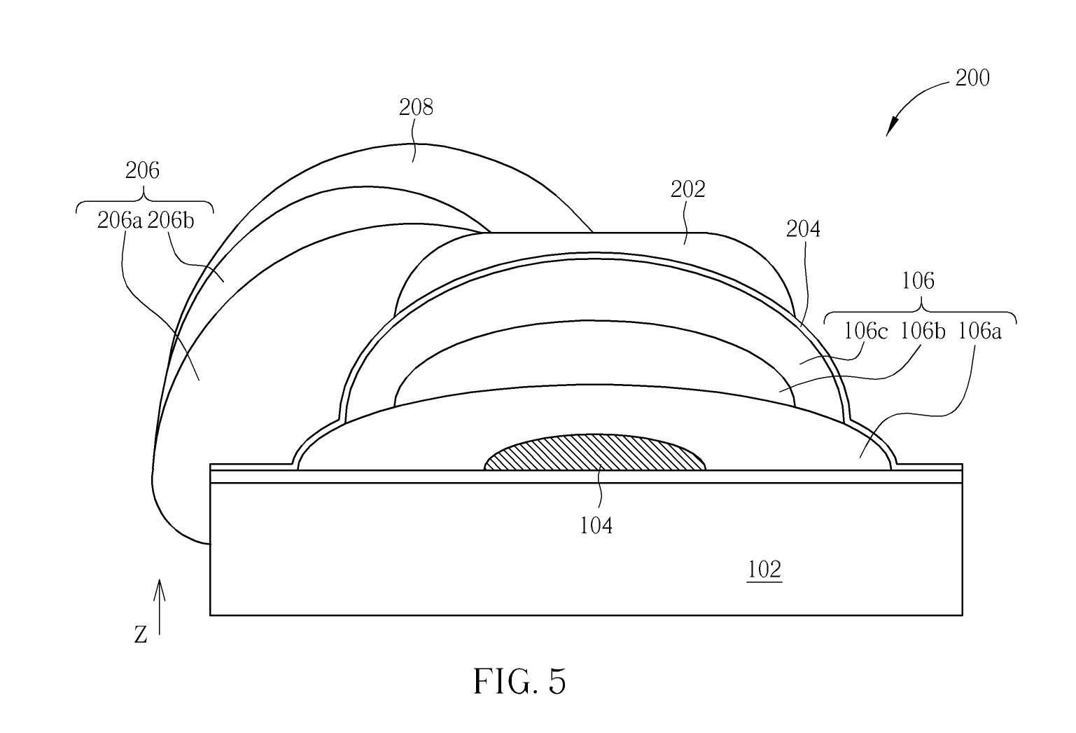

Referring to FIG. 5, FIG. 5 is a schematic diagram illustrating a cross-sectional view of a decoration plate according to a third embodiment of the present invention. As shown in FIG. 5, in comparison with the first embodiment, the decoration plate 200 of this embodiment further includes a first light-shielding layer 202 disposed on the color decoration layer 106 and used to shield the light penetrating through the color decoration layer 106. For example, when the color of the color decoration layer 106 is non-black, such as white or colored, the color decoration layer 106 has poor light-shielding performance and optical density. In this embodiment, the first light-shielding layer 202 is disposed on the color decoration layer 106 to enhance light-shielding performance and optical density. The first light-shielding layer 202 of this embodiment may include, for example, black or grey photoresist, black or grey ink or metallic material, but the present invention is not limited thereto. Also, the decoration plate 200 of this embodiment may optionally further include a buffer layer 204 disposed between the color decoration layer 106 and the first light-shielding layer 202 to avoid bad appearance of the decoration plate 200 caused by the material of the first light-shielding layer 202 polluting the color of the color decoration layer 106. The buffer layer 204 may include an insulating material, such as silicon oxide, but the present invention is not limited thereto. In other embodiment, the buffer layer 204 is a multilayer structure consisting of two layers or three layers. In the embodiment of the two layer structure, the two layers comprise an organic layer and a non-organic layer stacked with each other.

In this embodiment, the decoration plate 200 may optionally further include at least one frame decoration layer 206 and a second light-shielding layer 208. The frame decoration layer 206 may include a first frame decoration layer 206a and a second frame decoration layer 206b, sequentially stacked on a sidewall of the color decoration layer 106, and the frame decoration layer 206 extends onto a sidewall of the substrate 102. Accordingly, the frame decoration layer 206 can avoid a part of the first substrate 102 between the color decoration layer 106 and the sidewall of the first substrate 102 being exposed to affect the appearance of the decoration plate 200. In order to have uniform appearance of the decoration plate 200, the frame decoration layer 206 and the color decoration layer 106 may have a same color. For example, the frame decoration layer 206 and the color decoration layer 106 may include the same material, such as ink or photoresist, but the present invention is not limited herein. The frame decoration layer and the color decoration layer of the present invention may include different materials. In other embodiments, the frame decoration layer is not limited to be double layer structure and may be a single layer or multilayer structure. Furthermore, the second light-shielding layer 208 is disposed on the frame decoration layer 206 to prevent the light leakage at the edge of the decoration plate 200. The second light-shielding layer 208 of this embodiment may include, for example, black or grey photoresist, black or grey ink or metallic material, but the present invention is not limited thereto.

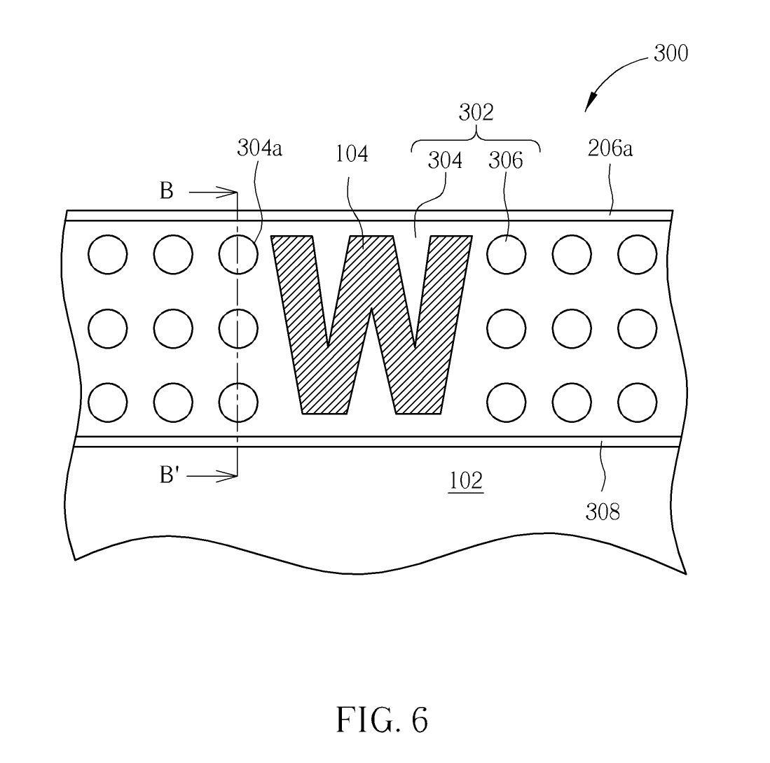

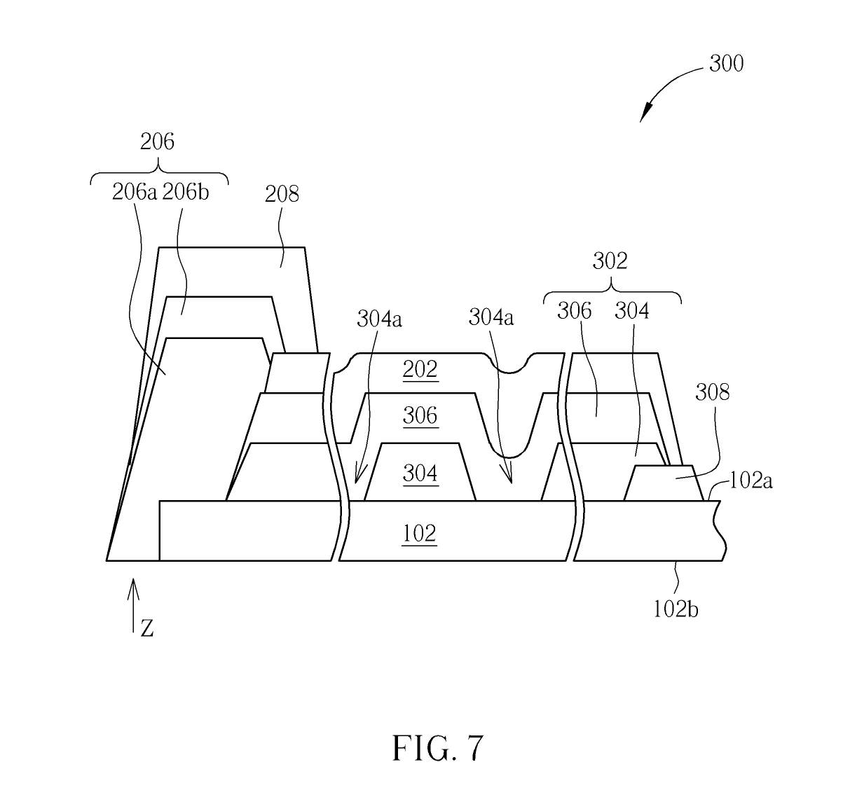

Referring FIG. 6 and FIG. 7, FIG. 6 is a schematic diagram illustrating a part of a top view of a decoration plate according to a fourth embodiment of the present invention, and FIG. 7 is a cross-sectional view of the decoration plate shown in FIG. 6 along a cross line B-B′. As shown in FIG. 6 and FIG. 7, in comparison with the second embodiment, the color decoration layer 302 of the decoration plate 300 of this embodiment includes a first color decoration layer 304 and a second color decoration layer 306, sequentially stacked on the inner surface 102a of the first substrate 102, and the color of the first color decoration layer 304 is different from the color of the second color decoration layer 306. For example, the first color decoration layer 304 of this embodiment is formed by pearl white ink, and the second color decoration layer 306 is formed by white ink, but the present invention is not limited herein. In other embodiments, the first color decoration layer and the second color decoration layer may include colors with different color schemes, such as blue and yellow belong to different color schemes, or colors with the same color schemes, such as red and pink belong to the same color scheme, or white and pearl white belong to the same color scheme. The colors of the first color decoration layer and the second color decoration layer are preferable to be distinguished by naked eyes, so as to show a stereoscopic feeling. In order to show the color of the second color decoration layer 306, the first color decoration layer 304 may have a plurality of patterned holes 304a exposing the inner surface 102a of the first substrate 102. Accordingly, the second color decoration layer 306 disposed on the first color decoration layer 304 is filled within the patterned holes 304a, and can be seen by the user from the outer surface 102b of the first substrate 102. In this case, the first color decoration layer 304 and the second color decoration layer 306 disposed in the patterned holes 304a can be seen simultaneously from the outer surface 102b of the decoration plate 300, thereby enriching the color of the pattern shown on the decoration plate 300 and increasing the stereoscopic feeling. In this embodiment, the first frame decoration layer 206a and the first color decoration layer 304 have a same color, and the second frame decoration layer 206b and the second color decoration layer 306 have a same color. For example, the first color decoration layer 304 and the first frame decoration layer 206a may be formed by pearl white ink, and the second color decoration layer 306 and the second frame decoration layer 206b may be formed by pearl pink ink in this embodiment, but the present invention is not limited thereto. The first color decoration layer, the first frame decoration layer, the second color decoration layer and the second frame decoration layer are not limited to be single layer respectively, and can be multi-layers respectively. The patterned holes may be any kind of geometric patterns, irregular patterns or designed patterns.

Furthermore, the decoration plate 300 of this embodiment may optionally further include an edge decoration layer 308 disposed between the inner surface 102a of the first substrate 102 and the color decoration layer 302, and the edge decoration layer 308 is located at a border of the first substrate 102 without overlapping the color decoration layer 302 and a border of the color decoration layer 302 in the projection direction Z perpendicular to the first substrate 102. This is to say that the edge decoration layer 308 is partially overlapped with the color decoration layer 302 in the projection direction Z perpendicular to the first substrate 102 to shield the rough edge of the color decoration layer 302 manufactured by the screen printing process, thereby straightening the appearance of the decoration plate 300. For example, when the color decoration layer 302 is formed by multi-layer structure, since alignment tolerance exists among the steps for forming the layers of the color decoration layer 302 in the manufacturing process, the edge of the formed color decoration layer 302 would be rough. In this embodiment, the edge decoration layer 308 formed at the border between the color decoration layer 302 and a part of the first substrate 102 without overlapping the color decoration layer 302 can effectively shield the rough edge of the color decoration layer 302. Also, the edge decoration layer 308 is formed on the inner surface 102a of the first substrate 102 before forming the color decoration layer 302, and a width of the edge decoration layer 308 is larger than the alignment tolerance to shield the rough edge.

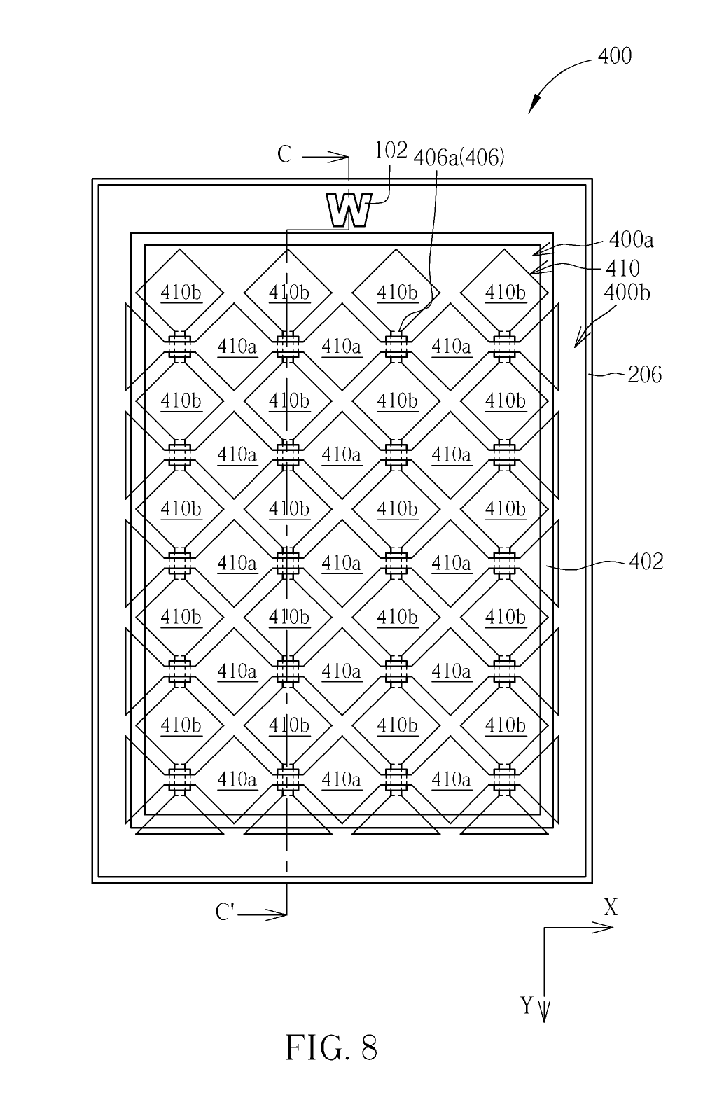

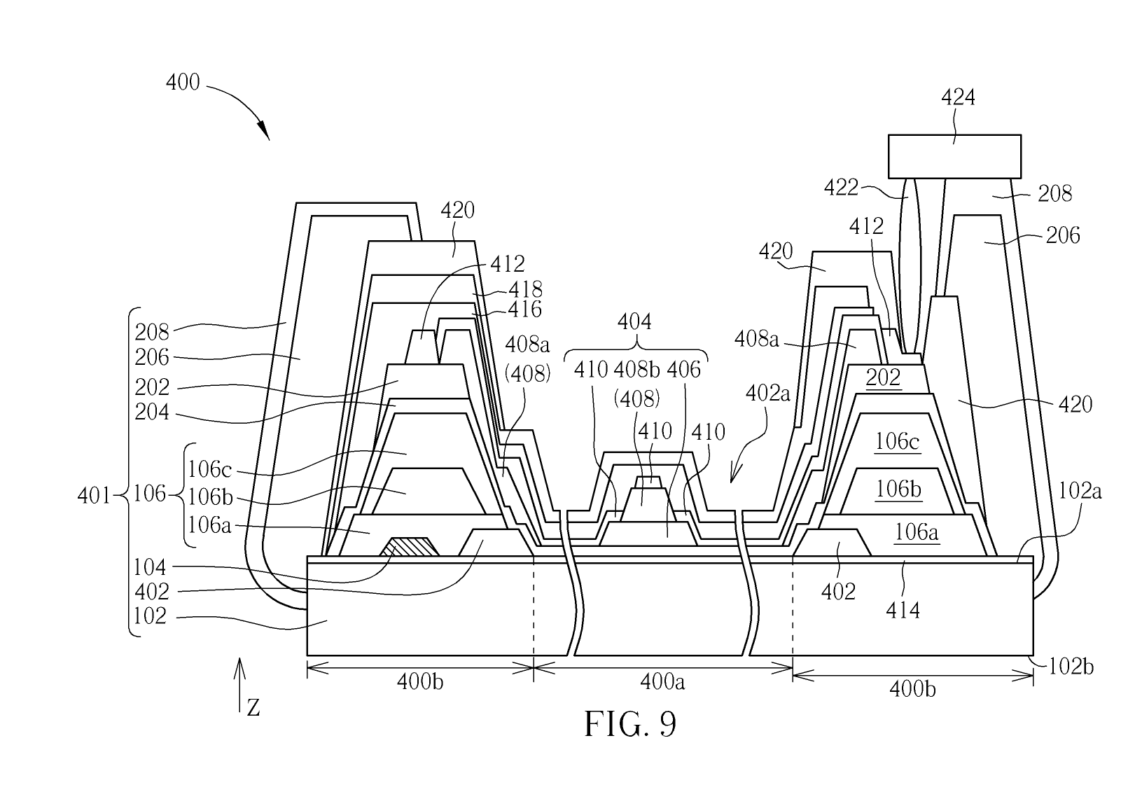

The decoration plate of the present invention may be applied to the touch panel, but is not limited thereto. Referring to FIG. 8 and FIG. 9, FIG. 8 is a schematic diagram illustrating a top view of a decoration plate according to a fifth embodiment of the present invention, and FIG. 9 is a cross-sectional view of the decoration plate shown in FIG. 8 along a cross line C-C′. As shown in FIG. 8 and FIG. 9, the touch panel 400 of this embodiment has a light-transmission region 400a and a light-shielding region 400b. The light-shielding region 400b is disposed adjacent to the light-transmission region 400a. In this embodiment, the light-shielding region 400b surrounds the light-transmission region 400a, but the present invention is not limited thereto. The light-shielding region of the present invention may be disposed near a part of the edge of the transmission region according to the requirements. In this embodiment, the following description takes the decoration plate of the above-mentioned third embodiment as an example of the decoration plate 401 of the touch panel 400, and the same part will be not detailed redundantly. The touch panel of the present invention is not limited to use the decoration plate of the third embodiment, and may use any one of the decoration plates of the above-mentioned embodiments or a combination of any two of the decoration plates of the above-mentioned embodiments. In comparison with the decoration plate of the third embodiment, the decoration plate 401 of this embodiment may further include an edge decoration layer 402 disposed between the inner surface 102a of the first substrate 102 and the color decoration layer 106 in the light-shielding region 402b, and the edge decoration layer 402 is partially overlapped with the color decoration layer 106 in the projection direction Z perpendicular to the first substrate 102. Since the edge decoration layer 402 and the color decoration layer 106 have a same color, the edge decoration layer 402 may be used to shield the rough edge of the color decoration layer 106. In other embodiments, the edge decoration layer 402 and the color decoration layer 106 may have different colors so as to provide the decoration frame to have different visual effects. Furthermore, a material of the edge decoration layer 402 and the material of the color decoration layer 106 may be the same material or different materials, such as ink or photoresist. In this embodiment, the material of the edge decoration layer 402 is photoresist, and the material of the color decoration layer 402 is ink. In other embodiment, the material of the edge decoration layer 402 may be ink, and the material of the color decoration layer 402 may be photoresist. Moreover, the edge decoration layer 402 has an opening 402a defining the light-transmission region 400a. The first light-shielding layer 202 and the second light-shielding layer 208 are disposed between a sidewall of the edge decoration layer 402 and a sidewall of the first substrate 102 such that the edge decoration layer 402, the first light-shielding layer 202 and the second light-shielding layer 208 cover the whole light-shielding region 400a, and the light cannot penetrate through the touch panel 400 in the light-shielding region 400a.

In addition, the touch panel 400 further includes at least one touch sensing unit 404 besides the decoration plate 401, and the touch sensing unit 404 is at least disposed in the light-transmission region 400a to sense a touch even close to or on the touch panel 400. In this embodiment, the touch sensing unit 404 is disposed on the inner surface 102a of the first substrate 102 in the light-transmission region 400a, and a part of the touch sensing unit 404 extends onto the edge decoration layer 402 and the color decoration layer 106 in the light-shielding region 400b. Specifically, the touch sensing unit 404 may include a first conductive pattern layer 406, a patterned insulating layer 408, and a second conductive pattern layer 410. The first conductive pattern layer 406 is disposed on the inner surface 102a of the first substrate 102 in the light-transmission region 400b, and made of a transparent conductive material or metallic materials, but the present invention is not limited thereto. The second conductive pattern layer 410 is disposed on the first conductive pattern layer 406, and a part of the second conductive pattern layer 410 is extended into the light-shielding region 400a from the light-transmission region 400a. The second conductive pattern layer 410 may include a transparent conductive material, such as indium tin oxide, indium zinc oxide, silver nanowires, carbon nanotube, grapheme or conductive polymer, or metal mesh. The metal mesh may include an opaque metal material or a metal material with a thickness that light can penetrate through, but the present invention is not limited thereto. The second conductive pattern layer of the present invention is not limited to be disposed on the first conductive pattern layer, and may be disposed between the first conductive pattern layer and the first substrate. Furthermore, the patterned insulating layer 408 includes an insulating part 408b disposed between the first conductive pattern layer 406 and the second conductive pattern layer 410 in the light-transmission region 400a to electrically insulate the first conductive pattern layer 406 from the second conductive pattern layer 410. The patterned insulating layer 408 includes organic insulating material or inorganic insulating material, such as silicon oxide, but the present invention is not limited thereto. It should be noted that the patterned insulating layer 408 optionally includes a buffer part 408a disposed between the second conductive pattern layer 410 and the first light-shielding layer 202, between the second conductive pattern layer 410 and the color decoration layer 106 and between the second conductive pattern layer 410 and the edge decoration layer 402, and the buffer layer 408a extends from the first light-shielding layer 202 along the sidewall of the color decoration layer 106 and the sidewall of the edge decoration layer 402 onto the first substrate 102. Accordingly, the buffer part 408a can mitigate the tapered angle where the second conductive pattern layer 410 being extended on the edge decoration layer 402, the color decoration layer 106 and first light-shielding layer 202 from the inner surface 102a of the first substrate 102, thereby avoiding disconnection of the second conductive pattern layer 410 disposed on the sidewall of first light-shielding layer 202, the sidewall of the color decoration layer 106 and the sidewall of the edge decoration layer 402. In other embodiments of the present invention, the buffer part may not be formed with the insulating part at the same time, and the buffer part and the insulating part may be formed in different processes or formed by different insulating materials.

The first conductive pattern layer 406 may include a plurality of connecting electrodes 406a, and the second conductive pattern layer 410 may include a plurality of first electrodes 410a and a plurality of second electrodes 410b. In this embodiment, the first electrodes 410a in a same row are electrically connected to one another along a first direction to form a first electrode series. Each connecting electrode 406a is disposed between any two of the second electrode 410b adjacent to each other in a same column, and the second electrodes 410b in the same column extend onto the connecting electrodes 406a, so that the second electrodes 410b in the same column can be electrically connected to one another through the connecting electrodes 406a along the second direction to form a second electrode series. The first electrode series cross the second electrode series, and the patterned insulating layer 408 is disposed between the first electrode series and the connecting electrodes 406a so as to insulate the first electrode series from the second electrode series. In this embodiment, the first direction is a horizontal direction X, and the second direction is a vertical direction Y, but the present invention is not limited thereto. In other embodiments, the first direction and the second direction may be the vertical direction and the horizontal direction respectively. Furthermore, the touch panel 400 of this embodiment further includes a conductive line layer 412 disposed on the first light-shielding layer 202 to contact with the second conductive pattern layer 410 in the light-shielding region 400b. Accordingly, the conductive line layer 412 can be used to electrically connect the touch sensing unit 404 to the outside control device or driving device. The conductive line layer 412 is formed by a conductive material, such as a metallic material with good conductivity, but the present invention is not limited thereto. Also, the touch panel 400 optionally further includes a bottom insulating layer 414 disposed between the first conductive pattern layer 406 and the first substrate 102 to enhance the adhesion between the first conductive pattern layer 406 and the second conductive pattern layer 410 and the first substrate 102. In this embodiment, the bottom insulating layer 414 covers the inner surface 102a of the first substrate 102, and may include, for example, silicon oxide, but the present invention is not limited thereto.

In this embodiment, the touch panel 400 optionally further includes a first passivation layer 416, a second passivation layer 418, and a third passivation layer 420, sequentially stacked on the touch sensing unit 404 and the conductive line layer 412 so as to provide protection and flatness. Besides the function of protection, the first passivation layer 416 and the second passivation layer 418 may have an optical matching function. The first passivation layer 416 may include silicon oxide; the second passivation layer 418 may include silicon nitride; and the third passivation layer 420 may include organic insulating material, but the present invention is not limited thereto. In other embodiments, the touch panel includes at least one of the first passivation layer, the second passivation layer and the third passivation layer, wherein the material of the at least one of the first passivation layer, the second passivation layer and the third passivation layer may include silicon oxide, silicon nitride, organic insulating material or a combination of at least two thereof. Moreover, the touch panel 400 includes an anisotropic conductive film 422 and a printed circuit board 424 electrically connected to the conductive line layer 412 to transfer the touch sensing signals through the anisotropic conductive film 422.

Also, in this embodiment, the frame decoration layer 206 and the second light-shielding layer 208 are disposed on the third passivation layer 420 in the light-shielding region 400b and at least overlap the first light-shielding layer 202 in the projection direction Z perpendicular to the first substrate 102. The frame decoration layer 206 and the color decoration layer 106 may have the same color, but the present invention is not limited herein. It should be noted that since the plurality of the decoration pattern layer 104, the plurality of the edge decoration layer 402, the plurality of color decoration layer 106, the plurality of the first light-shielding layer 202 and the plurality of touch sensing unit 404, are formed on a large substrate (mother glass) in sequence while manufacturing the touch panel 400, and the substrates with the size of the touch panel are formed by a cutting process, Then, the frame decoration layer 206 and the second light-shielding layer 208 are formed on the sidewall of the third passivation layer 420 and the sidewall of the first substrate 102 to complete the touch panel 400.

In other embodiments, if each device is directly formed on the surface of the divided substrate, the frame decoration layer and the second light-shielding layer may be ignored.

The touch panel of the present invention is not limited to the illustrated exemplary embodiment. To simplify the explanation and to clarify the comparison, the same components are denoted by the same numerals in the following exemplary embodiments or derivative embodiments, and the repeated parts are omitted herein for brevity.

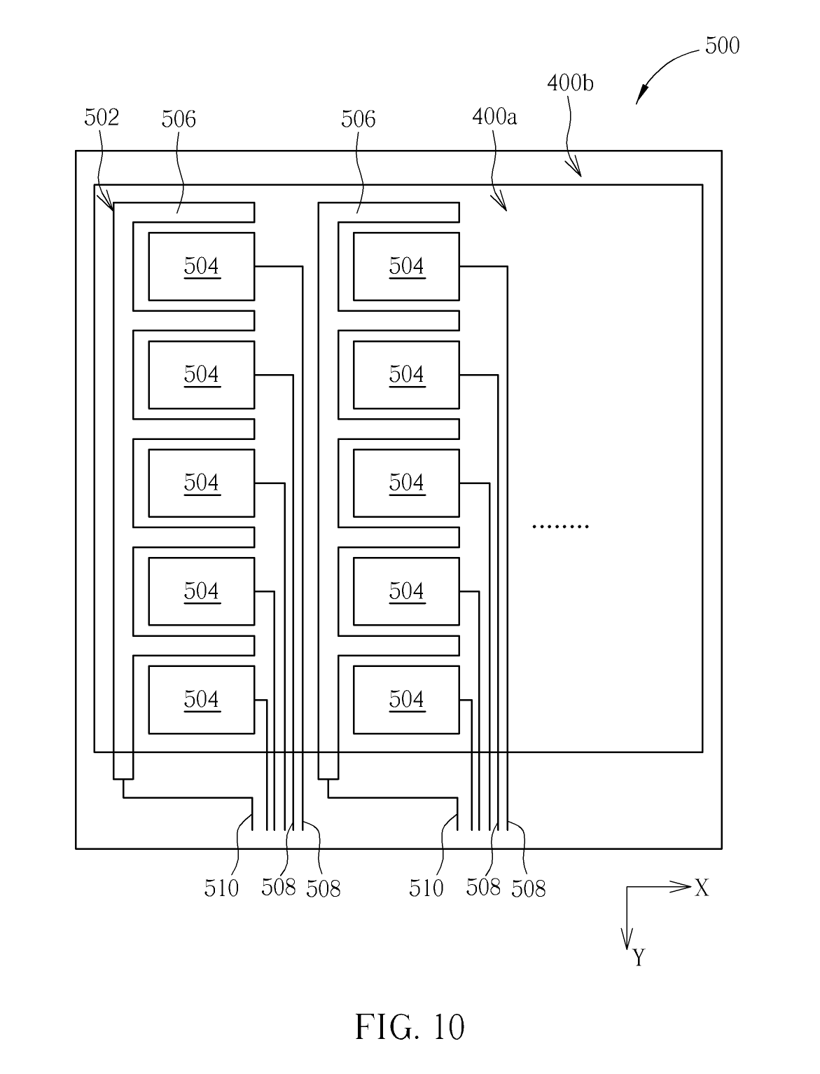

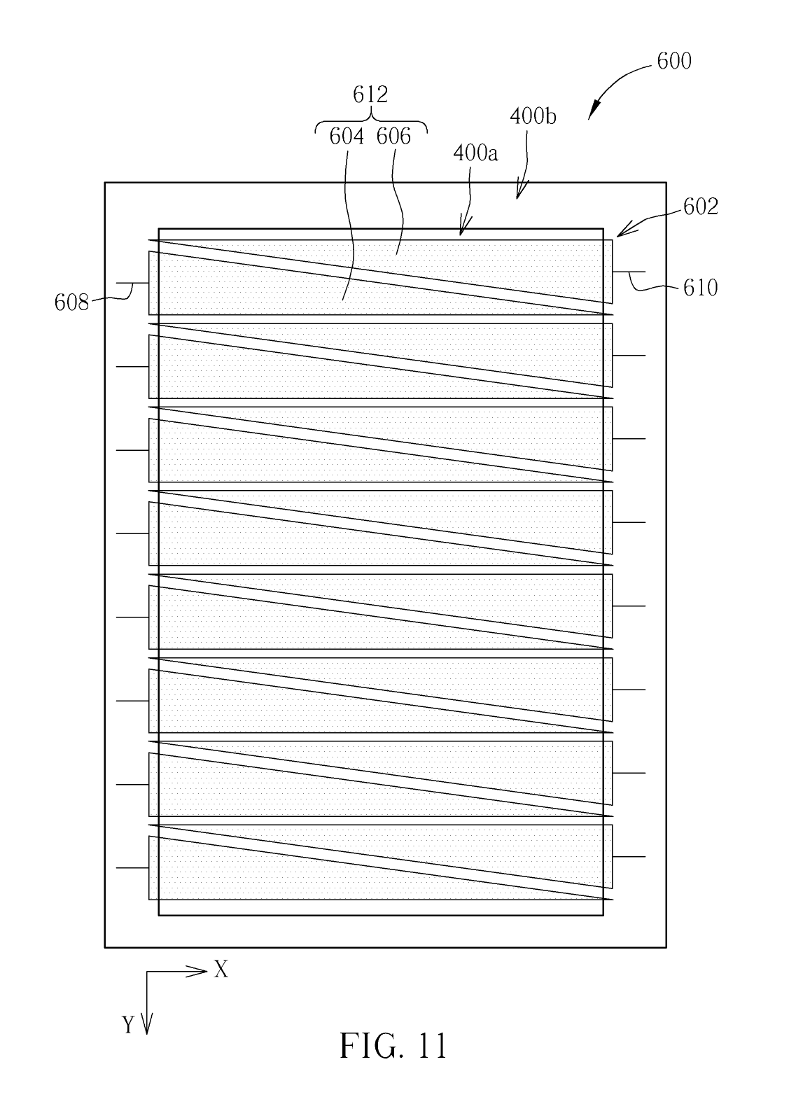

The touch sensing unit of the present invention is not limited to be formed by two conductive pattern layers, and may be formed by one conductive pattern layer. Referring to FIG. 10 and FIG. 11, FIG. 10 and FIG. 11 are schematic diagrams illustrating touch panels according to a sixth embodiment and a seventh embodiment of the present invention respectively. As shown in FIG. 10, in comparison with the touch panel of the fifth embodiment, the touch sensing unit 502 of the touch panel 500 of this embodiment is formed by one conductive pattern layer, and the configuration of the conductive pattern layer and the conductive line layer connected with the conductive pattern layer are designed to achieve the touch sensing function. Specifically, touch sensing unit 502 in this embodiment includes a plurality of first electrode 504, a plurality of second electrode 506, a plurality of first conductive lines 508, and a plurality of second conductive lines 510. The first electrodes 504 are arranged in an array configuration. Each second electrode 506 is disposed at a side of the first electrodes 504 in the same column and opposite to the first electrodes 504 in the same column, and partially extended to separate any two of the first electrodes 504 in the same column along the second direction Y to form a comb-like electrode. The first electrodes 504 are disposed in the light-transmission region 400a, and each first electrode 504 is electrically connected to the printed circuit board 424 through each first conductive line 508. The second electrodes 506 are disposed in the light-transmission region 400a, and each second electrode 506 is electrically connected to the printed circuit board 424 through each second conductive line 510. In other embodiments, each second electrode is disposed at the side of the first electrodes in the same row and partially extended to separate any two of the first electrodes in the same row. Also, the first conductive line and the second conductive line are made of a conductive material different from another conductive material for forming the first electrode and the second electrode.

As shown in FIG. 11, in comparison with the touch panel of the fifth embodiment, the touch sensing unit 602 of the touch panel 600 of this embodiment is formed by one conductive pattern layer. In this embodiment, the touch sensing unit 602 includes a plurality of first electrode 604, a plurality of second electrode 606, a plurality of first conductive lines 608, and a plurality of second conductive lines 610. Each first electrode 604 and each second electrode 606 are disposed opposite to each other and form an electrode pair 612 arranged in an array configuration. Each first electrode 604 is electrically connected to each first conductive line 608 and electrically connected to the printed circuit board 424 through each first conductive line 608. Each second electrode 606 is electrically connected to each second conductive line 610 and electrically connected to the printed circuit board 424 through each second conductive line 610. In this embodiment, the first electrodes 604 and the second electrodes 606 are preferably triangle electrodes, but the present invention is not limited herein. The first electrodes 604 and the second electrodes 606 may have different shapes to be uniformly arranged in the light-transmission region so as to achieve required touch sensing effect. In other embodiments, the first conductive line and the second conductive line are made of a conductive material different from another conductive material for forming the first electrode and the second electrode.

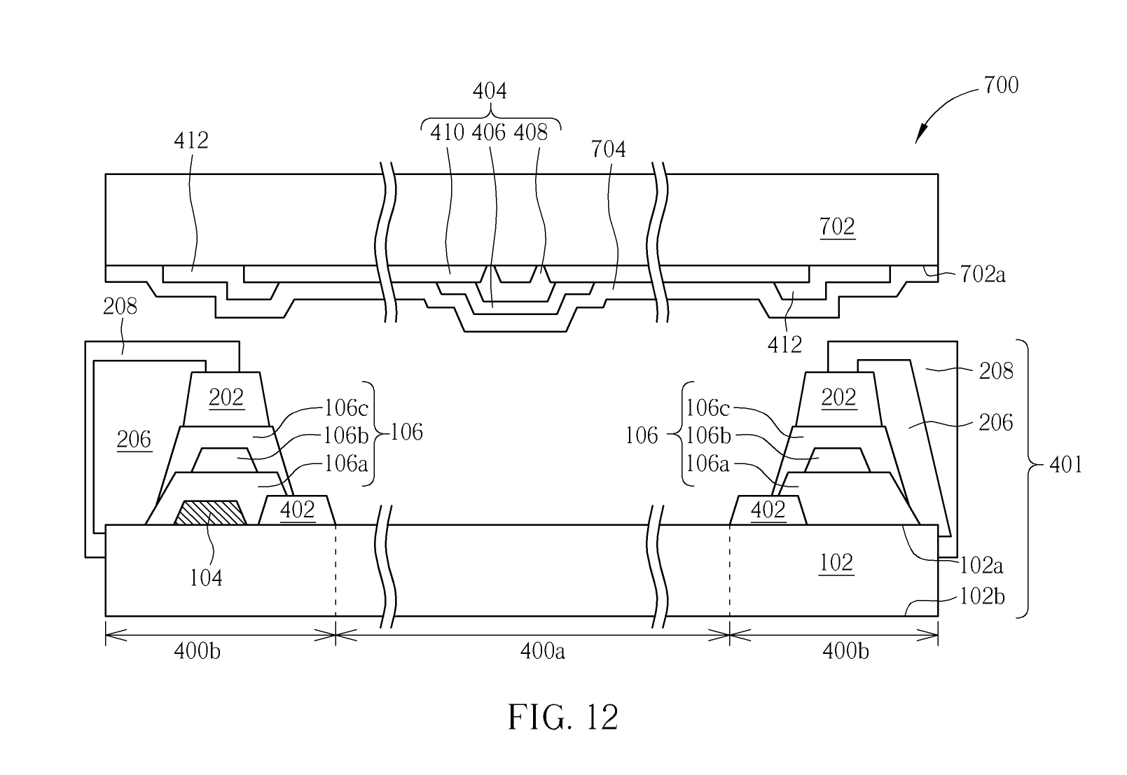

Referring to FIG. 12, FIG. 12 is a schematic diagram illustrating a cross-sectional view of a touch panel according to an eighth embodiment of the present invention. As shown in FIG. 12, in comparison with the touch panel of the fifth embodiment, the touch sensing unit and the layers of the decoration plate 401, such as the decoration pattern layer, of the touch panel of this embodiment are disposed on different substrates. In other words, besides the decoration plate 401 and the touch sensing unit 404, the touch panel 700 of this embodiment further includes a second substrate 702 disposed on the inner surface 102a of the first substrate 102 such that the first substrate 102 provides protection for the second substrate 702 with the touch sensing unit 404. A bottom surface 702a of the second substrate 702 corresponds to the first substrate 102. Also, the touch sensing unit 404, the conductive line layer 412 and the passivation layer 704 are formed on the bottom surface 702a of the second substrate 702, but the above devices may be formed on the top surface of the second substrate. The second substrate may be, for example, a glass substrate, a plastic substrate or a flexible film, wherein the material of the flexible film may be, for example, polyethylene terephthalate (PET) film, but the present invention is not limited thereto. In this embodiment, the passivation layer 704 may be at least one of the first passivation layer 416, the second passivation layer 418 and the third passivation layer 420, but the present invention is not limited thereto. In other embodiments, the second substrate may be an outer substrate of a display panel. In addition, the shape and the disposition of the touch sensing unit 404 may be the same as the touch sensing units of the fourth, fifth and sixth embodiments, and will not be detailed redundantly. Also, the decoration plate of this embodiment may be any one of the decoration plates of the above-mentioned embodiments, and will not be detailed redundantly.

As the above-mentioned description, the decoration pattern layer is formed on the inner surface of the first substrate prior to the step of forming the color decoration layer on the decoration pattern layer and the inner surface of the first substrate in the present invention, so that the pattern of the decoration pattern layer can be directly seen from the outer surface of the first substrate, and the color decoration layer can be served as a protection layer of the decoration pattern layer. Accordingly, the visual effect of the appearance of the pattern on the decoration plate and the touch panel can be improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A decoration plate having a light-shielding region, the decoration plate comprising:
a substrate;
a decoration pattern layer, disposed on the substrate in the light-shielding region to define at least one pattern in a projection direction perpendicular to the substrate; and
at least one color decoration layer, covering the decoration pattern layer and extending onto the substrate.

2. The decoration plate according to claim 1, wherein a color of the color decoration layer is black.

3. The decoration plate according to claim 1, wherein a color of the color decoration layer is non-black.

4. The decoration plate according to claim 3, wherein the at least one of the color decoration layer comprises a first color decoration layer and a second color decoration layer stacked on the substrate sequentially, and a color of the first color decoration layer is different from a color of the second color decoration layer, wherein the first color decoration layer comprises a plurality of patterned holes exposing the substrate, and the second color decoration layer is filled into the patterned holes.

5. The decoration plate according to claim 3, further comprising a first light-shielding layer disposed on the color decoration layer.

6. The decoration plate according to claim 5, further comprising a buffer layer disposed between the color decoration layer and the first light-shielding layer.

7. The decoration plate according to claim 1, further comprising at least one frame decoration layer disposed on a sidewall of the color decoration layer and extending onto a sidewall of the substrate, wherein the frame decoration layer and the color decoration layer have a same color.

8. The decoration plate according to claim 7, further comprising a second light-shielding layer disposed on the frame decoration layer.

9. The decoration plate according to claim 1, further comprising an edge decoration layer disposed between the substrate and the color decoration layer and partially overlapping the color decoration layer in the projection direction perpendicular to the substrate.

10. The decoration plate according to claim 1, wherein the decoration pattern layer comprises ink or photoresist.

11. The decoration plate according to claim 1, wherein the color decoration layer comprises ink or photoresist.

12. The decoration plate according to claim 9, wherein the material of the color decoration layer comprises ink and the material of the edge decoration layer comprises photoresist or metal.

13. The decoration plate according to claim 1, further comprising an edge decoration layer, disposed between an edge of the decoration pattern layer and the substrate, wherein the edge decoration layer partially overlaps the decoration pattern layer.

14. The decoration plate according to claim 13, wherein the material of the decoration pattern layer comprises ink and the material of the edge decoration layer comprises photoresist or metal.

15. A touch panel having a light-transmission region and a light-shielding region adjacent to the light-transmission region, the touch panel comprising:
a first substrate;
a decoration pattern layer, disposed on the first substrate in the light-shielding region to define at least one pattern in a projection direction perpendicular to the first substrate;
at least one color decoration layer, covering the decoration pattern layer and extending onto the first substrate; and
a touch sensing unit, at least disposed in the light-transmission region.

16. The touch panel according to claim 15, wherein the touch sensing unit is disposed on the first substrate, and a part of the touch sensing unit extends onto the color decoration layer in the light-shielding region.

17. The touch panel according to claim 15, further comprising a second substrate parallel to the first substrate, wherein the touch sensing unit is disposed on the second substrate.

18. The touch panel according to claim 15, wherein a color of the color decoration layer is black.

19. The touch panel according to claim 15, wherein a color of the color decoration layer is non-black.

20. The touch panel according to claim 19, wherein the at least one of the color decoration layer comprises a first color decoration layer and a second color decoration layer stacked on the first substrate sequentially, and a color of the first color decoration layer is different from a color of the second color decoration layer, wherein the first color decoration layer comprises a plurality of patterned holes exposing the first substrate, and the second color decoration layer is filled into the patterned holes.

21. The touch panel according to claim 19, further comprising a first light-shielding layer disposed on the color decoration layer.

22. The touch panel according to claim 21, further comprising a buffer layer disposed between the color decoration layer and the first light-shielding layer.

23. The touch panel according to claim 15, further comprising at least one frame decoration layer disposed on a sidewall of the color decoration layer and extending onto a sidewall of the first substrate, wherein the frame decoration layer and the color decoration layer have a same color.

24. The touch panel according to claim 23, further comprising a second light-shielding layer disposed on the frame decoration layer.

25. The touch panel according to claim 15, wherein the touch sensing unit comprises a first conductive pattern layer, a patterned insulation layer, and a second conductive pattern layer.

26. The touch panel according to claim 25, wherein the patterned insulation layer comprises a buffer part disposed between the second conductive pattern layer and the at least one color decoration layer in the light-shielding region.

27. The touch panel according to claim 25, wherein the patterned insulation layer comprises an insulation part disposed between the first conductive pattern layer and the second conductive pattern layer in the light-transmission region.

28. The touch panel according to claim 15, wherein the decoration pattern layer comprises ink or photoresist.

29. The touch panel according to claim 15, wherein the color decoration layer comprises ink or photoresist.

30. The touch panel according to claim 15, further comprising an edge decoration layer disposed between the first substrate and the color decoration layer and partially overlapping the color decoration layer in the projection direction perpendicular to the first substrate.

31. The touch panel according to claim 30, wherein the material of the color decoration layer comprises ink and the material of the edge decoration layer comprises photoresist or metal.

32. The touch panel according to claim 15, further comprising an edge decoration layer, disposed between an edge of the decoration pattern layer and the first substrate, wherein the edge decoration layer partially overlaps the decoration pattern layer.

33. The touch panel according to claim 32, wherein the material of the decoration pattern layer comprises ink and the material of the edge decoration layer comprises photoresist or metal.
